(19) United States
(12) Patent Application Publication
(10) Pub. No.: US 2025/0321136 A1
(43) Pub. Date: Oct. 16, 2025

(54) WARNING SYSTEM OF SENSOR COUPLING ISSUE FOR FIBER OPTIC-BASED MEASUREMENTS WITH A SOURCE LOCATED ABOVE A DISTRIBUTED ACOUSTIC SENSOR ARRAY

(71) Applicant: SCHLUMBERGER TECHNOLOGY CORPORATION, SUGAR LAND, TX (US)

(72) Inventors: Takashi Mizuno, Sugar Land, TX (US); Joel Herve Le Calvez, Sugar Land, TX (US)

(21) Appl. No.: 18/635,991

(22) Filed: Apr. 15, 2024

(51) Int. Cl. G01H 9/00; E21B 47/135; G01V 1/22

(52) U.S. Cl. CPC G01H 9/004; E21B 47/135; G01V 1/226

(57) ABSTRACT

Embodiments presented provide for a warning system and method that detects sensor coupling issues. The coupling issues sensed are for fiber optic based seismic measurements wherein the source is located above a distributed acoustic sensor array and the medium within which the sensors are located has unknown physical parameters.

### CROSS-REFERENCE TO RELATED APPLICATIONS

None.

### FIELD OF THE DISCLOSURE

Aspects of the disclosure relate to interactions between a sensor array (including optical fiber) and a surrounding medium. More specifically, aspects of the disclosure relate to a method for analyzing and minimizing noise in environments when an optical fiber is used for data transmission.

### BACKGROUND

The coupling of sensor refers to the interaction between the sensor package and its surrounding medium. In case of Distributed Acoustic Sensing (DAS), the coupling of sensor refers to the optical fiber and the surrounding medium, such as the borehole or the ground, in which the optical fiber is installed. The coupling affects the sensitivity of the sensing of the DAS system, and can also introduce noise and distortions into the acquired data.

The coupling mechanism depends on the installation environment of optical fiber used for DAS acquisition. For example, in a borehole environment, the fiber is typically lowered in the wellbore, cemented to the casing or the rock wall, and the coupling is primarily due to the condition of contact.

The coupling can be quantified using various metrics. These metrics can be estimated using analytical models, numerical simulations, or experimental measurements. Understanding the coupling is important for optimizing the performance of the DAS system and interpreting the acquired data accurately. Moreover, the coupling can be used as a tool for monitoring the physical properties and changes of the installation environment, such as the fluid level in a borehole, the deformation of a structure or the deformation of the surrounding formation.

Proper coupling and/or ability to quickly identify coupling issues is critical to not only acquire good quality data, but also minimize CO₂ footprint, as keeping acquisition timing to a minimum is enabled with the suggested alarm monitoring approach leveraging a source located above the DAS array.

Additionally, it is critical for proper 4D surveying to ensure that proper coupling is repeatable i.e., that there has been/were/are no critical changes in coupling (both values and locations).

Coupling between an optical fiber and the surrounding medium is a topic that has been studied in various contexts; however, in relation to a distributed acoustic sensor and quality assurance/quality control and alarm monitoring, little has been done. In the known conventional analysis, DAS data is analyzed and simulated using a sonic log. The signal quality is then quantified using synthetic methods. This method requires exact knowledge of the formation where the study is taking place. For surrounding medium/media that is unknown, no analysis techniques are known.

There is a need to provide an apparatus and methods that are easy to operate and will allow for a warning system for sensor coupling issues for fiber optic-based borehole seismic measurements.

There is a further need to provide apparatus and methods that do not have the drawbacks discussed above, namely the inability of analysis when the medium is unknown to researchers.

There is a still further need to reduce economic costs associated with operations and apparatus by providing a warning system for sensor coupling issues for fiber optic-based measurements.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are; therefore, not to be considered limiting of its scope, for the disclosure may admit to other equally effective embodiments without specific recitation. Accordingly, the following summary provides just a few aspects of the description and should not be used to limit the described embodiments to a single concept.

In one non-limiting embodiment, a method is disclosed. The method may comprise obtaining a normalized amplitude of signals from a fiber optic-based borehole seismic measurement. The method may further comprise computing depth derivatives of the normalized amplitude. The method may further comprise performing an outlier detection of the depth derivatives.

In another example embodiment, a computer readable medium is disclosed. The computer readable medium is configured to store a set of instructions to be performed on a computer, the computer readable medium being non-volatile. In this embodiment, the set of instructions comprises obtaining a normalized amplitude of signals from a fiber optic-based borehole seismic measurement. The set of instructions may also comprise computing depth derivatives of the normalized amplitude. The set of instructions may also comprise performing an outlier detection of the depth derivatives.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted; however, that the appended drawings illustrate only typical embodiments of this disclosure and are; therefore, not be considered limiting of its scope, for the disclosure may admit to other equally effective embodiments.

FIG. 1 is a sensor array configuration and propagation direction of transmission P-wave in accordance with one example embodiment of the disclosure.

FIGS. 2A, 2B, and 2C show coupling functions and amplitude decay curves for down-going P-wave for a medium where transmission coefficient varies randomly within five percent.

FIG. 3 is a depth derivative of a normalized amplitude disclosed in FIG. 2B.

FIG. 4 is a method to establish a warning system of sensor coupling issues for fiber optic-based borehole seismic measurement with a source located above a DAS array.

FIG. 5 illustrates a computing arrangement that the method of FIG. 4 may be performed upon.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood; however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, components, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood; however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

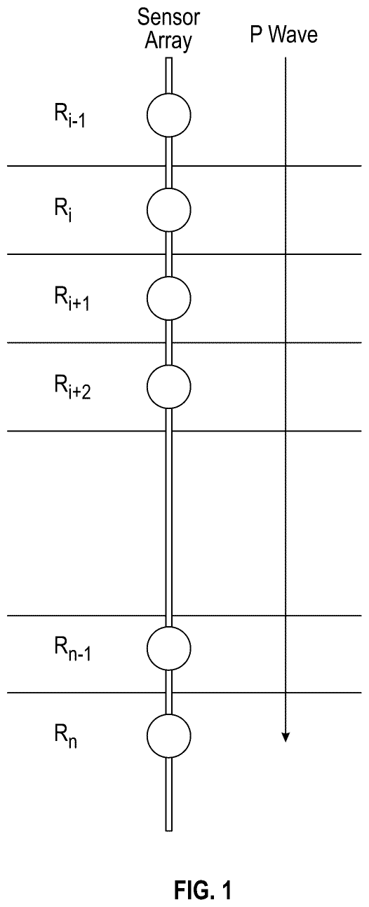

Referring to FIG. 1, sensor array configuration and propagation direction of transmission P-wave in accordance with one example embodiment of the disclosure. In the illustrated embodiment, the direction of transmission of the P-wave is illustrated. As illustrated, the P-wave generated propagates in the downward direction. The naming nomenclature for the sensor array is Rₙ at the bottom of the array and progresses upward from that direction to Rₙ₋₁. Upwardly, the array sensors eventually are defined as Rₙ, with sensors down the string having a positive nomenclature and sensors up the string from that reference point having a negative nomenclature. Other directions other than the downward direction are possible.

Amplitude values for sent and received data are provided for definition. Amplitude of seismic wave acquired by geophone can be written as convolution of S (source), P (path effect), and R (receiver effects including sensor response, in frequency domain,

$$( 1 )$$

$$V ( f ) = S ( f ) \times P ( f ) \times R\_V ( f ) . \qquad Equation 1.$$

In the case of plane wave propagation, amplitude changes may occur because of transmission and reflection at the medium interfaces. For analysis, it is assumed that there are layer boundaries in between receivers, considering that material properties change along the sensor array (FIG. 1). Such an assumption is accurate as a totally homogeneous strata is not found in the field.

A transmission wave is then considered in the analysis since it is a robust measurement in borehole seismic survey. Using material properties, the amplitude of transmitted wave changes according to the following equation:

$$\frac{{V}_{T i}}{{V}_{T i − 1}} = \frac{2 {M}_{i − 1}}{{M}_{i − 1} + {M}_{i}} \times \frac{{R}_{V i}}{{R}_{V i − 1}} . \qquad Equation 2$$

where the layer is indexed by i, and the number of index increases along the depth direction. M is the acoustic impedance (sometimes referred to as the value Z in classical literature). In terms of an arbitrary pair of receivers,

$$\frac{{V}_{T n}}{{V}_{Ti - 1}} = \frac{2 {M}_{i - 1}}{{M}_{i - 1} + {M}_{i}} \times \frac{2 {M}_{i}}{{M}_{i} + {M}_{i + 1}} \times … \frac{2 {M}_{n 1}}{{M}_{i + n - 1} + {M}_{i + n}} \times \frac{{R}_{V n}}{{R}_{Vi - 1}} . \qquad Equation 3$$

The coupling function is defined as follows,

$${R}_{V} = {R}_{S} \times {R}_{C} , \qquad Equation 4$$

where R_{S} is the instrument response of the receiver, and R_{C} is the coupling function. If the same receiver is used for entire array, equation (3) becomes,

$$\frac{{V}_{T n}}{{V}_{Ti - 1}} = \frac{2 {M}_{i - 1}}{{M}_{i - 1} + {M}_{i}} \times \frac{2 {M}_{i}}{{M}_{i} + {M}_{i + 1}} \times … \frac{2 {M}_{n - 1}}{{M}_{n - 1} + {M}_{n}} \times \frac{{R}_{C n}}{{R}_{Ci - 1}} . \qquad Equation 5$$

Equation (5) indicates the ratio of amplitudes of arbitrary receivers including the transmission coefficients between two receivers as well as the relative coupling of compared receivers. If the top receiver is used to obtain V_{Ti-1}, equation (5) is a variation of the normalized amplitude along the depth direction.

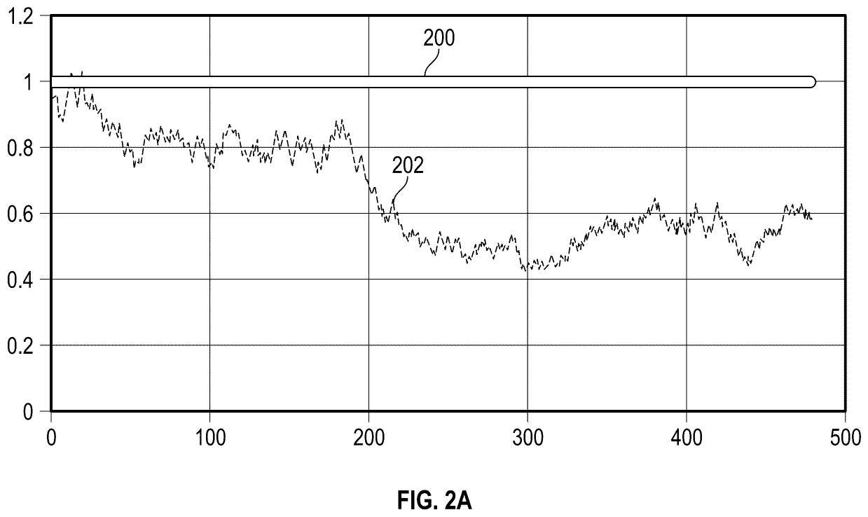

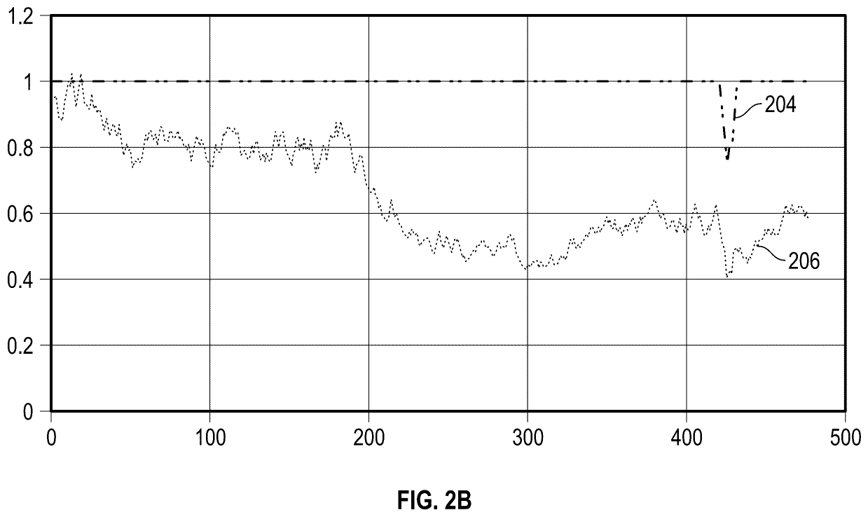

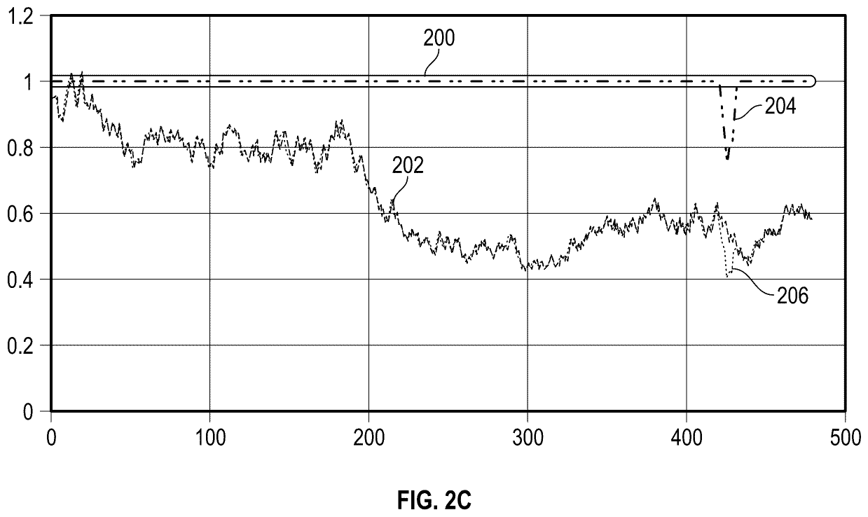

FIGS. 2A-2C show the value of the normalized amplitude along the depth direction for one of the examples of the model. In this model, random changes of 5% maximum are assumed in the variation of impedance. While impedance is randomly distributed from 0.95 to 1.05. The normalized amplitude decays with distance and varies by more than 40%. FIG. 2C shows the comparison of the amplitude changes when R_{C} is constant along the depth direction, and R_{C} changes with depth (minimum value of 0.75). The large amplitude changes do not correspond to the depths where R_{C} deviates from 1. Amplitude changing with depth could not detect changes in the coupling function R_{C}.

As illustrated in FIGS. 2A, 2B, and 2C, coupling functions and amplitude decay curves are provided. The amplitude decay curves are for down-going P waves for the medium where the transmission coefficient varies randomly within 5%. FIG. 2A shows the coupling function 200 and an amplitude decay curve 202 where there is full coupling. FIG. 2B shows the coupling function 204 and an amplitude decay curve 206, where the coupling has a defect between a depth of 420 and a depth of 430. Further, FIG. 2C shows FIG. 2B overlaid with FIG. 2A to show the differences in the coupling functions 200 and 204 as they relate to the differences between the amplitude decay curves 202 and 206. Thus, as can be seen in FIG. 20, it is hard to identify the depth where the coupling is defective.

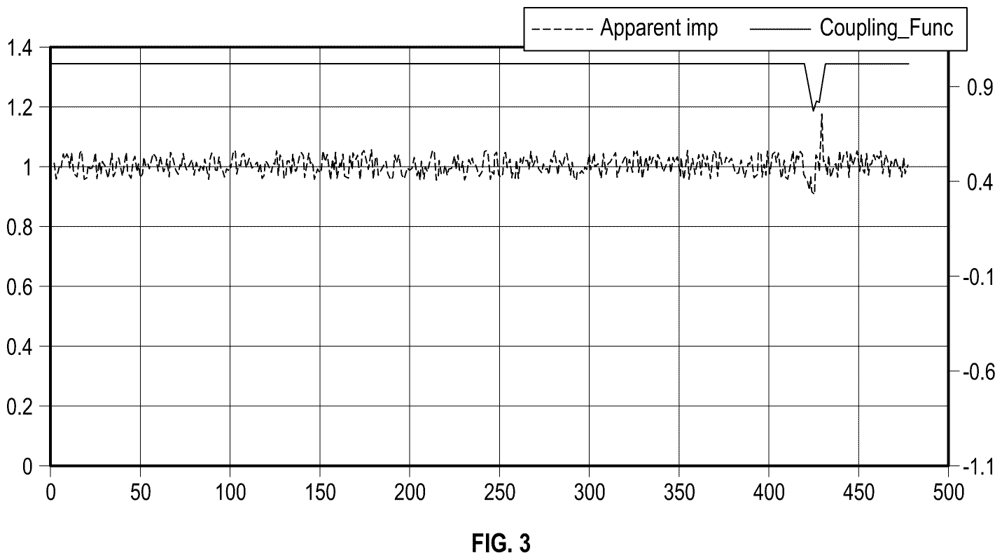

FIG. 3 shows the spatial derivative of the normalized amplitude using equation (5) for the same example as shown in FIG. 2B. Thus, FIG. 3 shows that the spatial derivative of the normalized amplitude helps to locate the depth at which there is a coupling issue, which can be seen as the spike in FIG. 3.

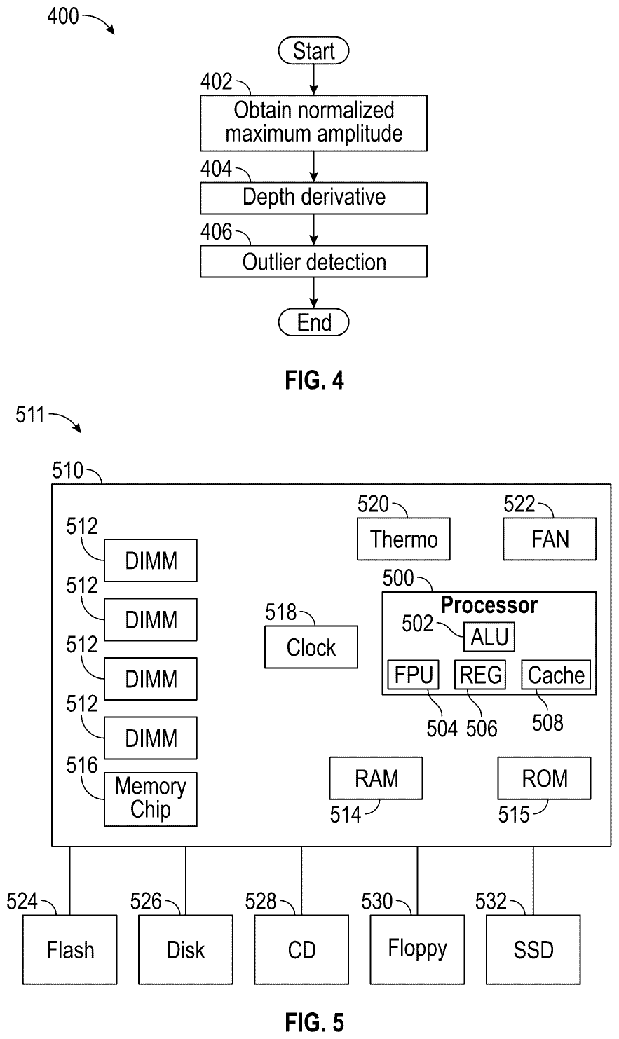

In one non-limiting example, a method is illustrated, in FIG. 4, presenting a warning system of sensor coupling issues for fiber optic-based borehole seismic measurement where the source is located above a distributed acoustic sensor array. The method 400 may be performed as follows:

At 402, obtaining a normalized maximum amplitude along depth for a Zero-offset or offset Vertical Seismic Profile (VSP) record. Time-picking is not necessary as long as the time window includes the direct P-wave arrival (see FIGS. 2A-2C jagged curve).

At 404, computing a depth derivative of the normalized amplitude (FIG. 3 bottom portion of the graph).

At 406, performing outlier(s) detection on the depth derivative of the normalized amplitude curve. Among others, the following methods may be used:
To detect outlier(s) based on database values.
To detect outlier(s) based on statistical testings for the curve obtained in FIG. 3.
To detect outlier(s) based on deep learning methods.

As will be understood, the method steps recited above may be placed in a non-volatile memory system that may be operated/performed by a computer or computing arrangement performed, for example, by the computer apparatus of FIG. 5.

In such embodiments, referring to FIG. 5, the computing apparatus is illustrated. In FIG. 5, a processor 500 is provided to perform computational analysis for instructions provided. The instruction provided, code, may be written to achieve the desired goal and the processor may access the instructions. In other embodiments, the instructions may be provided directly to the processor 500.

In other embodiments, other components may be substituted for generalized processors. These specifically designed components, known as application specific integrated circuits (“ASICs”) are specially designed to perform the desired task. As such, the ASIC's generally have a smaller footprint than generalized computer processors. The ASIC's, when used in embodiments of the disclosure, may use field programmable gate array technology, that allow a user to make variations in computing, as necessary. Thus, the methods described herein are not specifically held to a precise embodiment, rather alterations of the programming may be achieved through these configurations.

In embodiments, when equipped with a processor 500, the processor may have arithmetic logic unit (“ALU”) 502, a floating point unit (“FPU”) 504, registers 506 and a single or multiple layer cache 508. The arithmetic logic unit 502 may perform arithmetic functions as well as logic functions. The floating point unit 504 may be math coprocessor or numeric coprocessor to manipulate number for efficiently and quickly than other types of circuits. The registers 506 are configured to store data that will be used by the processor during calculations and supply operands to the arithmetic unit and store the result of operations. The single or multiple layer caches 508 are provided as a storehouse for data to help in calculation speed by preventing the processor 500 from continually accessing random access memory (“RAM”).

Aspects of the disclosure provide for the use of a single processor 500. Other embodiments of the disclosure allow the use of more than a single processor. Such configurations may be called a multi-core processor where different functions are conducted by different processors to aid in calculation speed. In embodiments, when different processors are used, calculations may be performed simultaneously by different processors, a process known as parallel processing.

The processor 500 may be located on a motherboard 510. The motherboard 510 is a printed circuit board that incorporates the processor 500 as well as other components helpful in processing, such as memory modules (“DIMMS”) 512, random access memory 514, read only memory, non-volatile memory chips 516, a clock generator 518 that keeps components in synchronization, as well as connectors for connecting other components to the motherboard 510. The motherboard 510 may have different sizes according to the needs of the computer architect. To this end, the different sizes, known as form factors, may vary from sizes from a cellular telephone size to a desktop personal computer size. The motherboard 510 may also provide other services to aid in functioning of the processor, such as cooling capacity. Cooling capacity may include a thermometer 520 and a temperature-controlled fan 522 that conveys cooling air over the motherboard 510 to reduce temperature.

Data stored for execution by the processor 500 may be stored in several locations, including the random access memory 514, read only memory, flash memory 524, computer hard disk drives 526, compact disks 528, floppy disks 530 and solid state drives 532. For booting purposes, data may be stored in an integrated chip called an EEPROM, that is accessed during start-up of the processor. The data, known as a Basic Input/Output System (“BIOS”), contains, in some example embodiments, an operating system that controls both internal and peripheral components.

Different components may be added to the motherboard 510 or may be connected to the motherboard 510 to enhance processing. Examples of such connections of peripheral components may be video input/output sockets, storage configurations (such as hard disks, solid state disks, or access to cloud-based storage), printer communication ports, enhanced video processors, additional random access memory and network cards.

The processor and motherboard may be provided in a discrete form factor, such as personal computer, cellular telephone, tablet, personal digital assistant or other component. The processor and motherboard may be connected to other such similar computing arrangement in networked form. Data may be exchanged between different sections of the network to enhance desired outputs. The network may be a public computing network or may be a secured network where only authorized users or devices may be allowed access.

As will be understood, method steps for completion may be stored in the random access memory, read only memory, flash memory, computer hard disk drives, compact disks, floppy disks and solid state drives.

Different input/output devices may be used in conjunction with the motherboard and processor. Input of data may be through a keyboard, voice, Universal Serial Bus (“USB”) device, mouse, pen, stylus, Firewire, video camera, light pen, joystick, trackball, scanner, bar code reader and touch screen. Output devices may include monitors, printers, headphones, plotters, televisions, speakers and projectors.

Embodiments of the disclosure are described next. In one non-limiting embodiment, a method is disclosed. The method may comprise obtaining a normalized amplitude of signals from a fiber optic-based borehole seismic measurement. The method may further comprise computing depth derivatives of the normalized amplitude. The method may further comprise performing an outlier detection of the depth derivatives.

In another example embodiment, the method may be performed wherein the performing the outlier detection of the depth derivatives is performed on a set of database values.

In another example embodiment, the method may be performed wherein the performing the outlier detection of the depth derivatives is based on statistical testings.

In another example embodiment, the method may be performed wherein the performing the outlier detection is based on a deep learning model.

In another example embodiment, the method may be performed wherein a source for the signals is located at an elevation higher than a height of a sensor array.

In another example embodiment, the method may be performed wherein the sensor array is an acoustic sensor array.

In another example embodiment, the method may be performed wherein the obtaining the normalized amplitude of signals is for a zero-offset record.

In another example embodiment, the method may be performed wherein the obtaining the normalized amplitude of signals is for an offset record.

In another example embodiment, the method may be performed wherein the offset record is a vertical seismic profile.

In another example embodiment, a computer readable medium is disclosed. The computer readable medium is configured to store a set of instructions to be performed on a computer, the computer readable medium being non-volatile. In this embodiment, the set of instructions comprises obtaining a normalized amplitude of signals from a fiber optic-based borehole seismic measurement. The set of instructions may also comprise computing depth derivatives of the normalized amplitude. The set of instructions may also comprise performing an outlier detection of the depth derivatives.

In another example embodiment, the computer readable medium set of instructions may provide for the performing the outlier detection of the depth derivatives is performed on a set of database values.

In another example embodiment, the computer readable medium set of instructions may provide for the performing the outlier detection of the depth derivatives is based on statistical testings.

In another example embodiment, the computer readable medium set of instructions may provide that the step of performing of the outlier detection is based on a deep learning model.

In another example embodiment, the computer readable medium set of instructions may provide that the signals are located at an elevation higher than a height of a sensor array.

In another example embodiment, the computer readable medium set of instructions may provide that the sensor array is an acoustic sensor array.

In another example embodiment, the computer readable medium set of instructions may provide that the obtaining the normalized amplitude of signals is for a zero-offset record.

In another example embodiment, the computer readable medium set of instructions may provide that the obtaining of the normalized amplitude of signals is for an offset record.

In another example embodiment, the computer readable medium set of instructions may provide that the offset record is a vertical seismic profile.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method, comprising:
obtaining a normalized amplitude of signals from a geophone and fiber optic-based borehole seismic measurement;
computing depth derivatives of the normalized amplitude; and
performing an outlier detection of the depth derivatives.

2. The method according to claim 1, wherein the performing the outlier detection of the depth derivatives is performed on a set of database values.

3. The method according to claim 1, wherein the performing the outlier detection of the depth derivatives is based on statistical testings.

4. The method according to claim 1, wherein the performing the outlier detection is based on a deep learning model.

5. The method according to claim 1 wherein a source for the signals is located at an elevation higher or lower than a height of a sensor array, and exciting wavefield along the array.

6. The method according to claim 5, wherein the sensor array is an acoustic sensor array.

7. The method according to claim 1, wherein the obtaining the normalized amplitude of signals is for a zero-offset record.

8. The method according to claim 1, wherein the obtaining the normalized amplitude of signals is for an offset record.

9. The method according to claim 8, wherein the offset record is a vertical seismic profile.

10. A computer readable medium configured to store a set of instructions to be performed on a computer, the computer readable medium being non-volatile, wherein the set of instructions comprises:
obtaining a normalized amplitude of signals from a fiber optic-based borehole seismic measurement;
computing depth derivatives of the normalized amplitude; and
performing an outlier detection of the depth derivatives.

11. The computer readable medium according to claim 10, wherein the performing the outlier detection of the depth derivatives is performed on a set of database values.

12. The computer readable medium according to claim 10, wherein the performing the outlier detection of the depth derivatives is based on statistical testings.

13. The computer readable medium according to claim 10, wherein the performing the outlier detection is based on a deep learning model.

14. The computer readable medium according to claim 10 wherein a source for the signals is located at an elevation higher than a height of a sensor array.

15. The computer readable medium according to claim 14, wherein the sensor array is an acoustic sensor array.

16. The computer readable medium according to claim 11, wherein the obtaining the normalized amplitude of signals is for a zero-offset record.

17. The computer readable medium according to claim 11, wherein the obtaining the normalized amplitude of signals is for an offset record.

18. The computer readable medium according to claim 17, wherein the offset record is a vertical seismic profile.
